(19) United States
(12) Patent Application Publication
(10) Pub. No.: US 2012/0258620 A1
(43) Pub. Date: Oct. 11, 2012

(54) ELECTRICAL CONNECTOR CONFIGURED TO CONNECT TO A FLEX CABLE

(76) Inventors: Motomu Kajiura, Tokyo (JP); Jeroen de Bruijn, Loon Op Zand (NL); Yasutoshi Kameda, Kisarazu-shi (JP)

(21) Appl. No.: 13/359,953

(22) Filed: Jan. 27, 2012

Related U.S. Application Data
(60) Provisional application No. 61/437,533, filed on Jan. 28, 2011.

(51) Int. Cl. H01R 13/62; H01B 13/20

(52) U.S. Cl. 439/329; 29/828

(57) ABSTRACT

In accordance with one embodiment, an electrical connector includes a connector housing, and at least one electrical terminal supported by the connector housing. The electrical terminal defines a mating portion and a mounting portion. The electrical connector includes a lock movable between an unlocked position and a locked position so as to facilitate insertion of a flex cable and subsequent locking of the flex cable to the mounting portion.

### RELATED APPLICATIONS

This claims the benefit of U.S. patent application Ser. No. 61/437,533 filed Jan. 28, 2011, the disclosure of which is hereby incorporated by reference as if set forth in its entirety herein. The present application is related by subject matter to U.S. design patent application Ser. No. 29/384,319 filed Jan. 28, 2011, U.S. patent application Ser. No. 29/384,320 filed Jan. 28, 2011, and U.S. patent application Ser. No. 29/384/322, the subject matter of each of which is hereby incorporated by reference as if set forth in its entirety herein.

### TECHNICAL FIELD

The present disclosure relates to electrical connectors, and in particular relates to an electrical terminal configured to connect to a flexible printed circuit.

### BACKGROUND

Electrical connectors conventionally include a housing that retains a plurality of electrically conductive terminals that define opposed mounting ends and mating ends configured to be placed in electrical communication with respective first and second complementary electrical devices. For instance, flat flex cables are widely used to connect the first electrical device to the mounting end of an electrical connector. Accordingly, when the electrical connector is mated to the second electrical device, the first and second electrical devices are placed in electrical communication. Flat flex cables have found increasing use as a replacement for costly and heavy-weight cable harnesses.

### SUMMARY

In accordance with one embodiment, an electrical connector is configured to mount to a flex cable. The electrical connector includes a connector housing that defines a housing reception slot. The electrical connector further includes at least one electrical terminal supported by the housing and configured to electrically connect to a flex cable. The electrical terminal defines a mating end and a mounting end, the mounting end disposed in the reception slot and spaced from an opposed inner housing surface. The flex cable is configured to be received between the mounting end and the opposed inner housing surface. The electrical connector further includes a lock including a lock body and a locking member that extends from the lock body and is configured to be inserted into the housing reception slot. The lock is movable from an unlocked position to a locked position, such that when in the locked position, the locking member is disposed between the mounting end and the opposed inner housing surface, so as to capture the flex cable between the locking member and the mounting end..

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1A is a perspective view of an electrical connector assembly constructed in accordance with one embodiment, including an electrical connector and a flat flexible cable mounted to the electrical connector;

FIG. 1B is a perspective view of the electrical connector illustrated in FIG. 1A, including a connector housing, a plurality of electrical terminals supported by the connector housing, and a lock;

FIG. 2A is a perspective view of the connector housing of the electrical connector illustrated in FIG. 1B;

FIG. 2B is perspective view of one of the electrical terminals of the electrical connector illustrated in FIG. 1B;

FIG. 2C is a perspective view of the lock of the electrical connector illustrated in FIG. 1B;

FIG. 2D is a perspective view of a portion of the flat flexible cable illustrated in FIG. 1A;

FIG. 3A is a perspective assembly view showing attachment of the electrical terminals to the connector housing;

FIG. 3B is a perspective assembly view showing attachment of the lock to the connector housing;

FIG. 3C is a perspective view of the electrical connector illustrated in FIG. 1B, showing the lock in an unlocked position;

FIG. 3D is a sectional side elevation view of the electrical connector illustrated in FIG. 3C;

FIG. 4A is a perspective view of the electrical connector illustrated in FIG. 3C, showing the lock advanced toward a locked position;

FIG. 4B is a perspective view of the electrical connector illustrated in FIG. 4A, showing the lock in the locked position;

FIG. 4C is a sectional side elevation view of the electrical connector illustrated in FIG. 4B, showing the lock in the locked position;

FIG. 5A is a sectional side elevation view of the electrical connector illustrated in FIG. 3C, showing the flex cable inserted into the connector housing with the lock in the unlocked position;

FIG. 5B is a sectional side elevation view of the electrical connector illustrated in FIG. 5A, but showing the lock in the locked position;

FIG. 6A is a perspective view of an electrical connector assembly constructed in accordance with another embodiment, including an electrical connector and a flat flexible cable mounted to the electrical connector;

FIG. 6B is another perspective view of the electrical connector assembly illustrated in FIG. 6A;

FIG. 7 is a diagrammatic view of a portion of a vehicle having a safety restraint system that includes the electrical connector assembly that can be constructed as illustrated in FIGS. 1 and 2A-B;

FIG. 8 is a top plan view of a seat sensor device used in the vehicle safety restraint system shown in FIG. 7;

FIG. 9 is a bottom plan view of a portion of the seat sensor device shown in FIG. 8;

FIG. 10 is an enlarged perspective view of a portion of the seat sensor device shown in FIG. 8, but without showing the flexible printed circuit may merely for the sake of clarity;

FIG. 11 is a partial top plan view of a portion of the flexible printed circuit mat, the frame, and three terminals prior to connection of a Hall effect sensor assembly; \

FIG. 12 is a perspective view of a first housing member of the sensor assembly shown in FIG. 10;

FIG. 13 is a cross sectional view of a first subassembly of the sensor assembly shown in FIG. 10 comprising the first housing member shown in FIG. 12 and a Hall effect sensor;

FIG. 14 is a perspective view of the first subassembly shown in FIG. 13 with a cutaway section;

FIG. 15 is a perspective view of a second housing member used in the sensor assembly shown in FIG. 10;

FIG. 16 is a cross sectional view of a second subassembly used in the sensor assembly shown in FIG. 10 comprising the second housing member shown in FIG. 15 and a permanent magnet;

FIG. 17 is a perspective view as in FIG. 10 with the second subassembly moved towards a depressed position;

FIG. 18 is a top plan view of one of the terminals used to connect the sensor assembly shown in FIG. 10 to the flexible printed circuit mat;

FIG. 19 is a side elevation view of the terminal shown in FIG. 18; and

FIG. 20 is a cross sectional view of the terminal shown in FIG. 19 taken along line 20-20.

### DETAILED DESCRIPTION

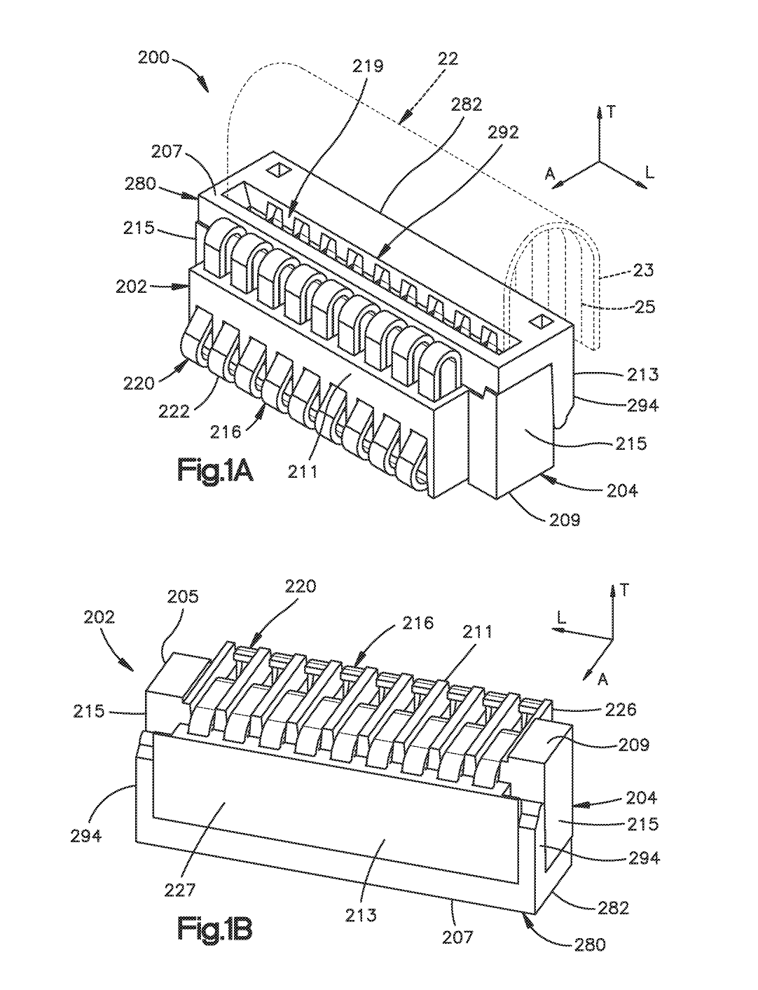

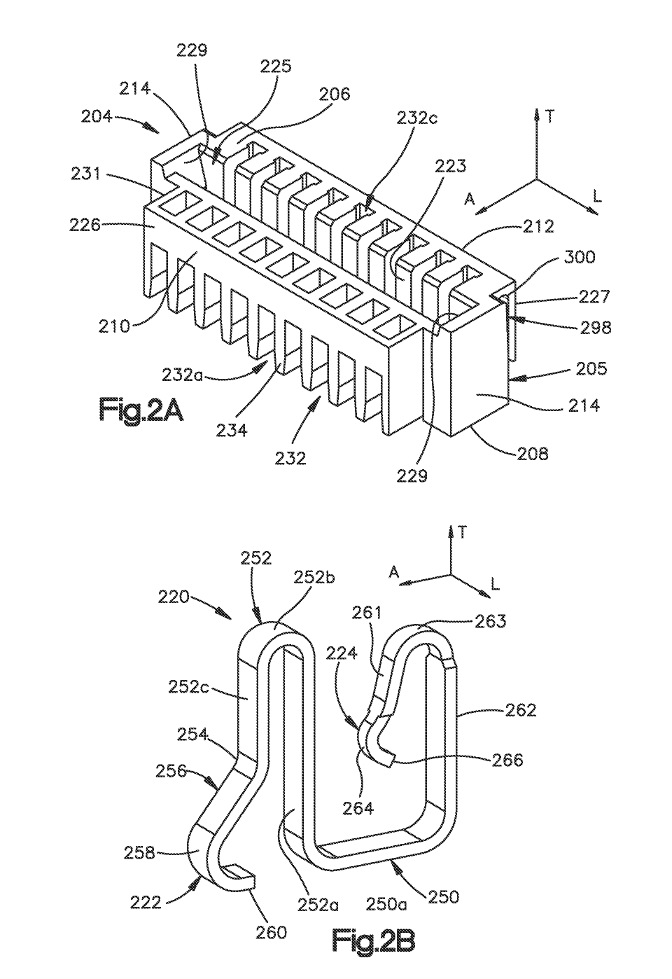

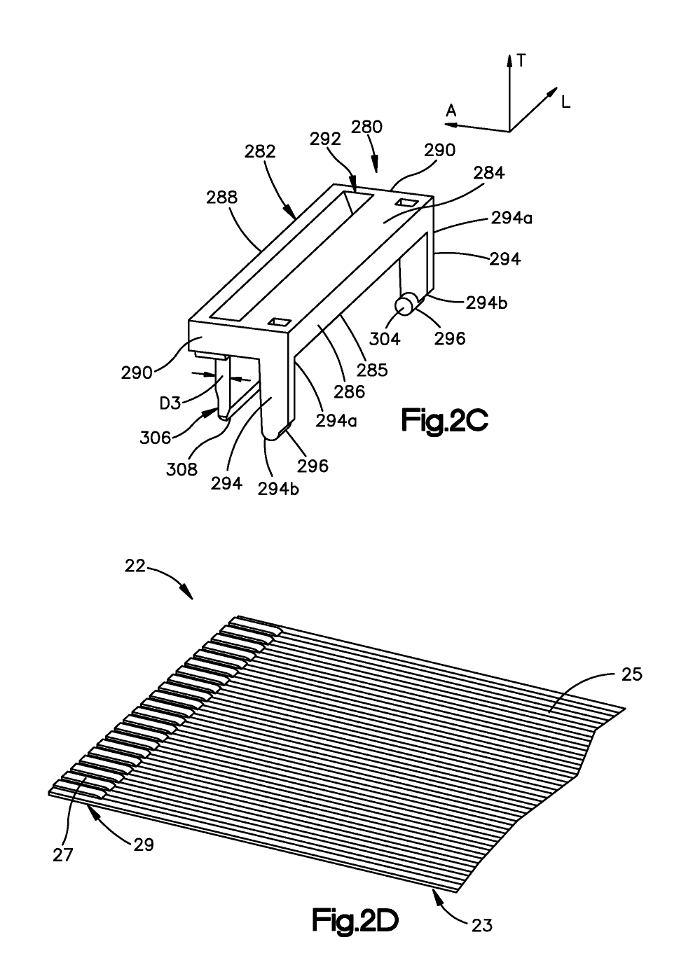

Referring initially to FIGS. 1A-B, an electrical connector assembly 200 includes an electrical connector 202 and a flat flex cable 22, also referred to as a flexible printed circuit (FPC) or a flat flexible cable (FCC), that is configured to be mounted to the electrical connector 202. The electrical connector 202 includes a connector housing 204 and at least one electrical terminals such as a plurality of electrical terminals 220 supported by the connector housing 204. The flex cable 22 is configured to be mounted onto the electrical connector 202 so as to be placed in electrical communication with the electrical terminals 220. For instance, as further shown in FIG. 2D, the flex cable 22 can include a flexible dielectric substrate 23 such as a polymeric film that carries a plurality of electrical traces in the form of conductive layers 25 carried by the substrate 23 and extending along the length of the substrate 23. The flex cable 22 includes a plurality of electrically conductive contact pads 27 supported by the substrate 23 at a first end 29 of the flex cable 22. The contact pads 27 are in electrical communication with respective ones of the conductive layers 25, and are configured to electrically connect to the electrical terminals 220. Thus, the flex cable 22 is configured to be placed in electrical communication with the electrical terminals 220 at the first end 29, and in electrical communication with a complementary electrical device at a second end that can be opposite the first end 29. For instance, as illustrated in FIG. 1A, the electrical connector 202 defines a reception slot 219 that is sized to receive and retain an end of the flex cable 22 so as to electrically connect the flex cable 22 to the electrical terminals 220. Thus, the flex cable 22 is configured to be inserted into the reception slot so that the contact pads 27 are placed in electrical contact with respective ones of the electrical terminals 220.

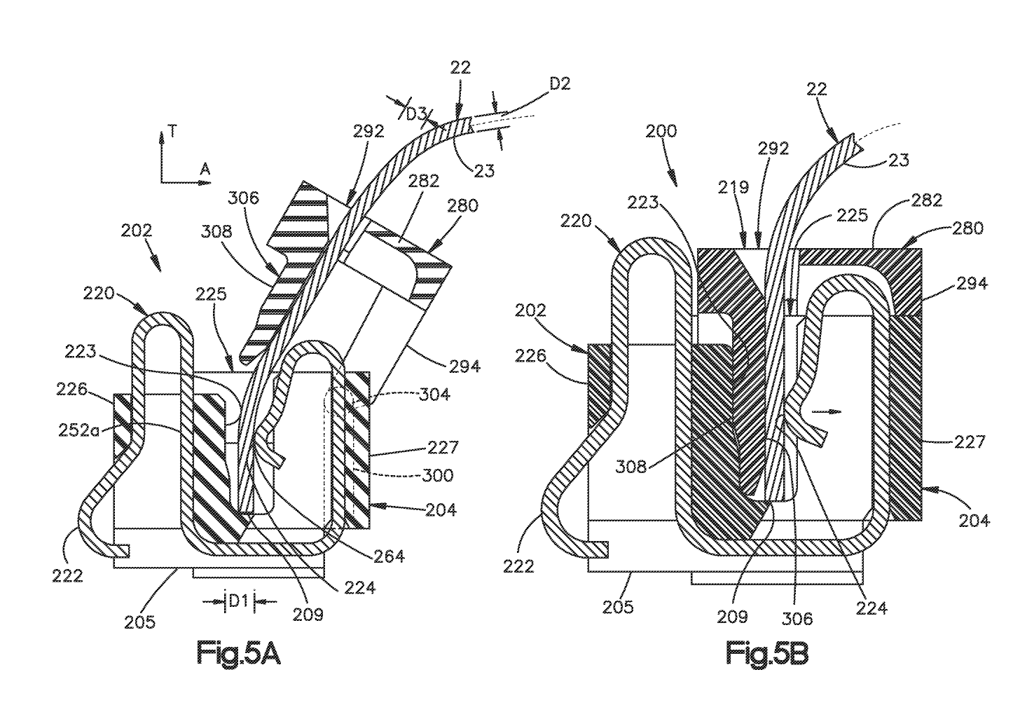

The electrical connector 202 further includes a lock 280 that is configured to be removably attached to the connector housing 204. The lock 280 is movable between a locked position (FIG. 5A) and an unlocked position (FIG. 5B). When the lock 280 is in the unlocked position, the flex cable 22 can be inserted into the reception slot 219 such that the contact pads 27 are aligned with respective ones of the electrical terminals 220. When the lock 280 is iterated to the locked position, the lock 280 releasably secures the flex cable 22 to the electrical connector 202 such that the contact pads 27 are in electrical communication with the respective electrical terminals 220. When the lock 280 is again iterated to the unlocked position, the contact pads 27 can be removed from electrical communication with the electrical terminals 220, and the flex cable 22 can be removed from the electrical connector 202.

With continuing reference to FIGS. 1A-B, the electrical connector 202 defines a top end 207 and an opposed bottom end 209, a front end 211 and an opposed rear end 213, and opposed sides 215. The opposed sides 215 are spaced apart along a longitudinal direction L, the front end rear ends 211 and 213 are spaced apart along a lateral direction A that is substantially perpendicular with respect to the longitudinal direction L. The front end 211 is spaced from the rear end along a forward direction, and the rear end 213 is spaced from the front end 211 along to rearward direction. The top and bottom ends 207 and 209 are spaced apart along a transverse direction T that is substantially perpendicular with respect to the lateral direction A and the longitudinal direction L. The top end 207 is spaced from the bottom end 209 along an upward direction, and the bottom end 209 is spaced from the top end 207 along a downward direction. In accordance with the illustrated embodiment, the transverse direction T is oriented vertically, and the longitudinal and lateral directions L and A are oriented horizontally, though it should be appreciated that the orientation of the electrical connector 202 may vary during use. In accordance with the illustrated embodiment, the electrical connector 202 is illustrated as elongate in the longitudinal direction L, and the electrical terminals 220 are spaced along a row direction that extends along the longitudinal direction L. The reception slot 219 extends down into the top end 207 along the transverse direction, and can terminate in the connector housing 204 or can extend through the electrical connector 202.

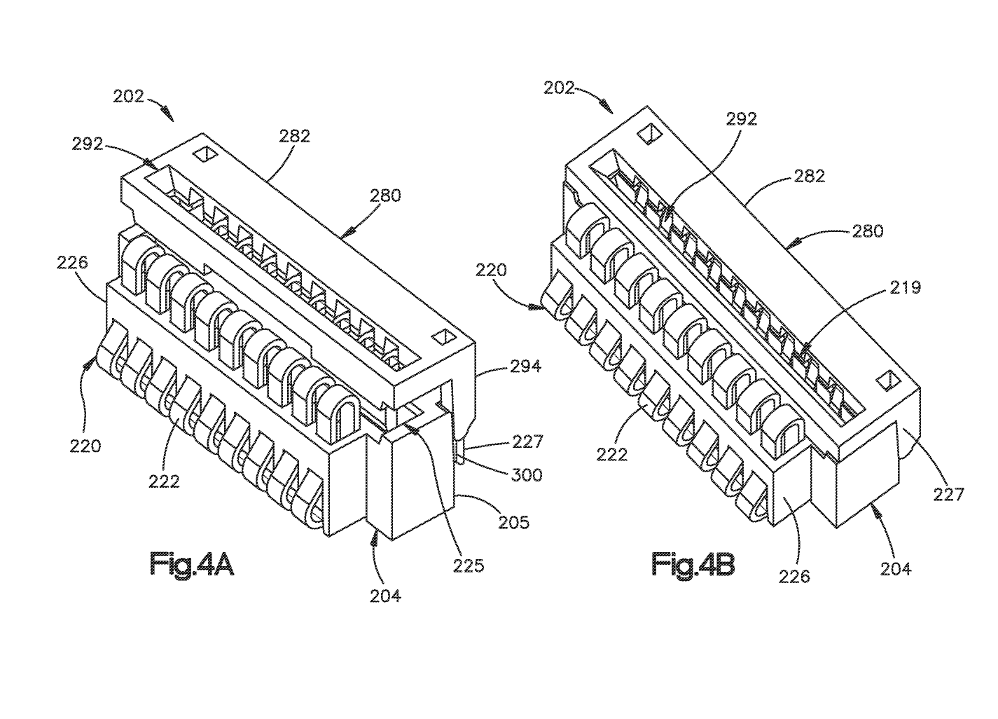

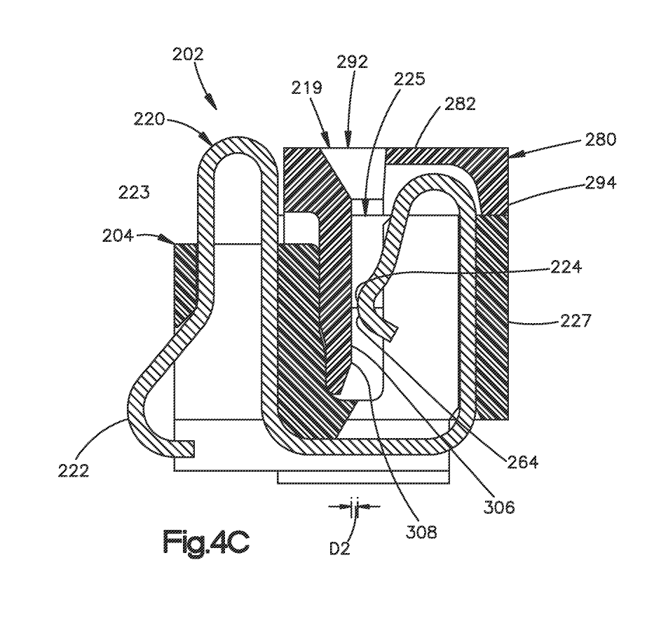

The electrical connector 202 defines a mating interface 216 that can be disposed proximate to the front end 211 and forwardly spaced from the connector housing 204 along the lateral direction A. The electrical connector 202 further defines a mounting interface 218 disposed in the reception slot 219 located proximate to the rear end 213 and located inside the connector housing 204 (see FIG. 4C). The mounting interface 218 is configured to operatively engage the flex cable 22 so as to place the flex cable 22 in electrical communication with the electrical terminals 220, while the mating interface 216 is configured to operatively engage a complementary electrical component, such as a second electrical connector, so as to place the electrical terminals 220 in electrical communication with the second electrical connector.

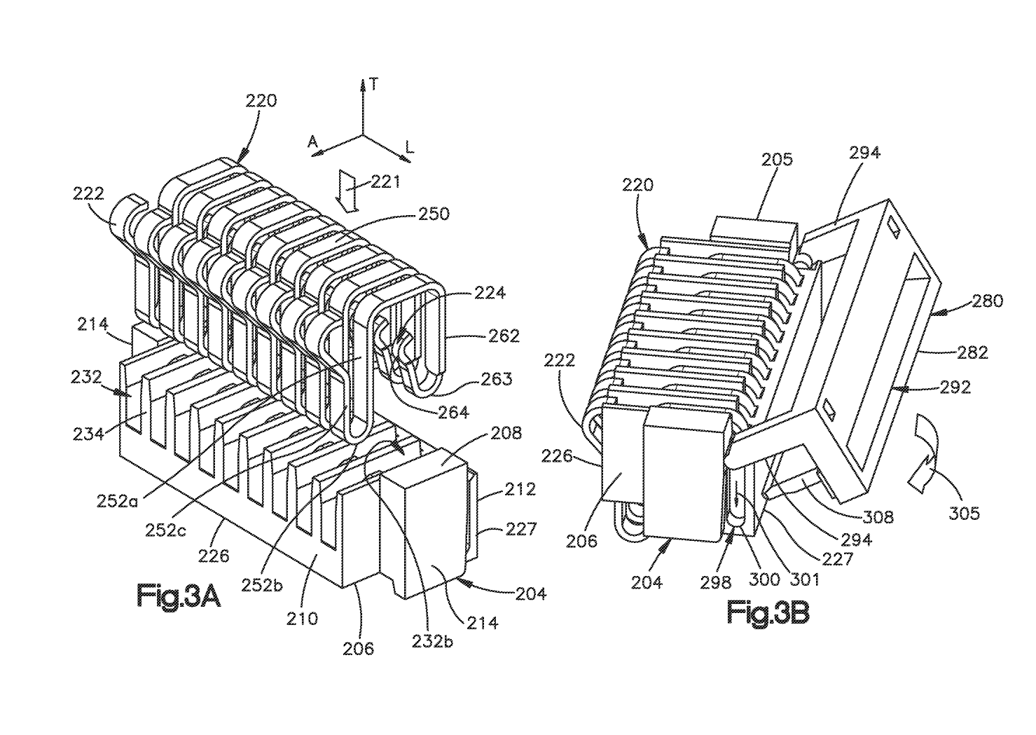

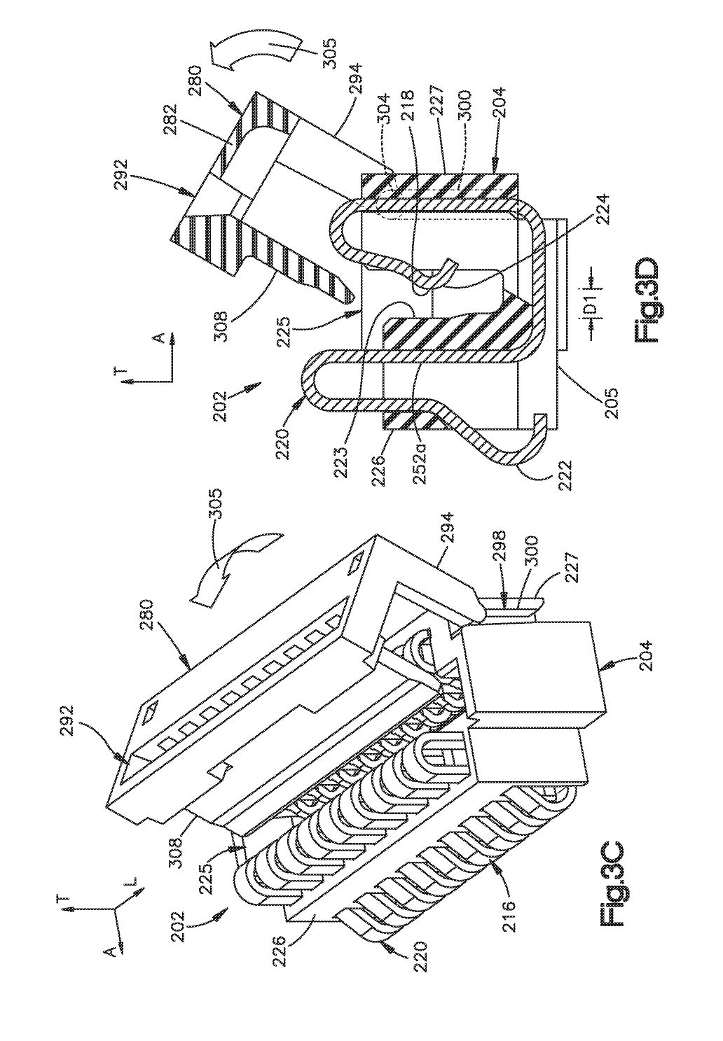

Referring also to FIG. 2A and 3A, the connector housing 204 is dielectric or electrically insulative, and defines a top end 206, an opposed bottom end 208, a front end 210, an opposed rear end 212, and opposed sides 214 that correspond to the top end 207, bottom end 209, front end 211, opposed rear end 213, and sides 215 of the electrical connector 202, respectively. Thus, the opposed sides 214 are spaced apart along the longitudinal direction L, the front end rear ends 210 and 212 are spaced apart along the lateral direction A, and the top and bottom ends 206 and 208 are spaced apart along the transverse direction T. The connector housing 204 includes a substantially rectangular housing body 205, a first or front retention wall 226 disposed forward with respect to the housing body 205, and a second or rear retention wall 227 disposed rearward with respect to the housing body 205. In accordance with the illustrated embodiment, the front and rear retention walls 226 and 227, respectively, are integral and monolithic with the housing body 205 and thus each other, though the front and rear retention walls 226 and 227, respectively, and the housing body 205 can be discreetly attached to each other as desired.

The connector housing 204 defines a housing reception slot 225 that extends into the housing body 205 along the transverse direction T down from the top end 206 toward the bottom end 208. The housing reception slot 225 can terminate at a location between the top end 206 and the bottom end 208 inside the housing body 205, or can extend through the bottom end 208 and thus through the connector housing 204. The connector housing 204 defines at least one first inner housing surface 223, which can define a pair of side surfaces that are spaced from each other along the lateral direction A, and a second pair of opposed inner housing surfaces 229, which can define end surfaces, that are connected between the inner housing surfaces 223. Each of the first and second inner housing surfaces 223 and 229 can at least partially define the housing reception slot 225. The at least one inner housing surface 223 can extend along a plane that includes the transverse direction T and the longitudinal direction L. The housing reception slot 225 is sized to receive and retain the first end 29 of the flat flex cable 22. For instance, the inner housing surfaces 223 can extend along a length in the longitudinal direction L that is substantially equal to or greater than a corresponding length of the first end 29 of the flat flex cable 22 along the longitudinal direction L when the flat flex cable 22 is disposed in the housing reception slot 225. Furthermore, the second inner housing surfaces 229 can extend along a width in the lateral direction A that is substantially equal to or greater than a corresponding thickness of the first end 29 of the flat flex cable 22 along the lateral direction A when the flat flex cable 22 is disposed in the housing reception slot 225. Thus, the reception slot 219 of the electrical connector 202 can be at least partially defined by the housing reception slot 225.

The electrical connector 202 includes a plurality of terminal retention members illustrated as retention slots 232 that can extend at least into or through connector housing 204 and can be sized and configured to receive and retain the electrical terminals 220 in the connector housing 204. The connector housing 204 defines divider walls 234 that are spaced along the longitudinal direction and define adjacent retention slots 232, such that the retention slots can extend between adjacent divider walls 234 along the longitudinal direction L. For instance, each of the retention slots 232 can include a first or front portion 232a that extends at least into or through the front retention wall 226, a second or middle portion 232b that extends at least into or through the housing body 205, and a third or rear portion 232c that extends at least into or through the rear retention wall 227. In accordance with the illustrated embodiment, the retention slots 232, including at least one up to all of the front portion 232a, middle portion 232b, and rear portion 232c, extend down through the bottom end 208 of the front retention wall 226, the housing body 205, and the rear retention wall 227, respectively, along the transverse direction T. Furthermore, the retention slots 232, including at least one up to all of the front portion 232a, middle portion 232b, and rear portion 232c, extend up through the top end 206 of the front retention wall 226, the housing body 205, and the rear retention wall 227, respectively, along the transverse direction T. The retention slots 232, for instance at the front portion 232a, can further extend forward through the front retention wall 226 along the lateral direction A. The retention slots 232, for instance at the rear portion 232c can terminate in the rear retention wall 227 with respect to rearward extension along the lateral direction A. Thus, the retention slots 232 can extend rearwardly through the front retention wall 226, through the housing body 205, and into but not through the rear retention wall 227 along the lateral direction A. The housing reception slot 225 can extend along the longitudinal direction L between the sides 214, and can further extend along the lateral direction A between the front portion 232a and the rear portion 232c of the retention slots 232.

The divider walls 234 can extend along the lateral direction A from the front retention wall 226, through the housing body 205, and into the rear retention wall 227. Thus, the divider walls 234 can extend from the front end 210 of the connector housing 204 toward the rear end 212 of the connector housing 204. The divider walls 234 can terminate laterally inward of the rear end 212 of the connector housing 204, such that the retention slots 232 are open to the front end 210 of the connector housing 204, and closed with respect to the rear end 212 of the connector housing 204 as described above. The divider walls 234 can further extend up in the transverse direction T from the bottom end 208 of the connector housing 204 toward the top end 206 of the connector housing 204. For instance, the divider walls 234 can extend up from the bottom end 208 of the connector housing 204 at the rear retention wall 227 to the top end 206 of the connector housing 204 at the rear retention wall 227. Accordingly, the third or rear portion 232c of the retention slots 232 can be open at the bottom end 208 of the connector housing 204 at the rear retention wall 227, extend vertically through the rear retention wall 227, and be open at the top end 206 of the connector housing 204 at the rear retention wall 227. The divider walls 234 can define one of the inner housing surfaces 223 that is opposite the other of the inner housing surfaces 223 so as to define the housing reception slot 225 therebetween.

The divider walls 234 can extend vertically up from the bottom end 208 of the connector housing 204 at the housing body 205 along the transverse direction T toward the top end 206 of the connector housing 204 at the housing body 205, but terminate at a location inwardly spaced from the top end 206 along the transverse direction T, so as to define the housing reception slot 225 that extends along the transverse direction T from the divider wall 234 at the housing body 205 and the top end 206 at the housing body 205. The divider walls 234 can further extend up from the bottom end 208 at the front retention wall 226 along the transverse direction T toward the top end 206 at the front retention wall 226, but can terminate at a location inwardly spaced from the top end 206 at the front retention wall 226, such that the front retention wall 226 defines encircled windows 231 that extend into the top end 206 and define the first or front portion 232a of the retention slots 232. The windows 231 can be dimensioned so as to receive intermediate region 252b of the respective electrical terminals 220 therein, as will now be described.

Referring now to FIGS. 1A-2B, the electrical terminals 220 are electrically conductive and retained by the connector housing 204. The electrical connector 202 can include any number of electrical terminals 220 as desired, such as nine in accordance with one embodiment. The electrical terminals 220 each define a mating end 222 disposed proximate to the mating interface 216, an opposed mounting end 224 disposed proximate to the mounting interface 218, and an intermediate portion 250 connected between the mating end 222 and the mounting end 224. When mounted onto the connector housing 204, the mating ends 222 extend transversely along the front end 211 of the electrical connector 202 and the mounting ends 224 extend transversely inside the reception slot 219. For instance, in accordance with the illustrated embodiment, the mating ends 222 extend out the connector housing 204, and the mounting ends 224 are disposed within the connector housing 204.

For instance, the mating end 222 extends at least into the front retention wall 226, the intermediate portion 250 extends at least into the housing body 205, and the mounting end 224 extends at least into the rear retention wall 227. In accordance with the illustrated embodiment, the mating ends 222 can extend through respective ones of the windows 231 along the transverse direction T, and can further extend forward along the lateral direction A through the front portion 232a of the respective retention slots 232 of the front retention wall 226. Thus, at least a portion of the mating ends 222 can extend out from the connector housing 204. The intermediate portion 250 can extend through the middle portion 232b of the respective retention slots 232 along the lateral direction A between the front retention wall 226 and the rear retention wall 227. The mounting ends 224 can extend into the rear portion 232c of the respective retention slots 232, and can extend forward along the lateral direction A through the rear portion 232c of the respective retention slots 232 and into the housing reception slot 225 (see FIG. 3D).

In accordance with the illustrated embodiment, the intermediate portion 250 is illustrated as a leg that extends vertically and defines a first or outer end 250a, and an opposed second or outer end 250b. The mating end 222 is connected to the first outer end 250a, and the mounting end 224 is connected to the second outer end 250b. In accordance with the illustrated embodiment, the mating end 222 includes a retention arm 252 that defines a proximal region 252a, an intermediate region 252b, and a distal region 252c. The proximal region 252a extends laterally rearward from the first outer end 250a of the intermediate portion 250 in a direction angularly offset from the intermediate portion 250. As illustrated, the proximal region 252a of the mating end 222 extends substantially perpendicular with respect to the intermediate portion 250. The intermediate region 252b defines a substantially u-shaped bend of substantially 180° from the proximal region 252a. Accordingly, the distal region 252c extends from the intermediate region 252b along a direction substantially parallel to the proximal region 252a to an elbow 254, and a contact portion 256 that extends laterally forward and transversely down from the elbow 254. The contact portion 256 is illustrated as substantially hook-shaped and defines a contact surface 258 and a distal end 260 that extends laterally rearward from the contact surface 258 toward the intermediate portion 250. The distal end 260 can be substantially laterally aligned with the intermediate portion 250 as illustrated.

The mounting end 224 includes a mounting arm 262 that extends transversely upward from the second outer end 250b of the intermediate portion 250 in a direction angularly offset from the intermediate portion 250. As illustrated, the mounting arm 262 extends along a direction substantially perpendicular with respect to the intermediate portion 250 and substantially parallel to the proximal region 252a of the mating end 222. The mounting arm 262 extends transversely up to a bent end 263, which can be referred to as a substantially u-shaped bend as it causes the electrical terminal 220 to reverse direction, extends to a flared contact portion 261 that can be angularly offset with respect to the mounting arm 262. The substantially u-shaped bend defined by the bent end 263 is slightly less than 180° in accordance with the illustrated embodiment. The electrical terminal 220 further includes a contact surface 264 that is disposed laterally forward with respect to the contact portion 261. The contact surface 264 bends along a direction toward the mounting arm 262 and terminates at a terminal end 266. It should be appreciated that the electrical terminals 220 can be referred to as battery-type terminals in that both the mating end 222 and the mounting end 224 are configured to resiliently flex or compress with respect to each other about the substantial u-shaped bent end defined by the intermediate region 252b and the bent end 263, respectively.

Referring again to FIGS. 1A-2B and 3A, the electrical connector 202 can be assembled by attaching the electrical terminals 220 to the connector housing 204. In accordance with the illustrated embodiment, the electrical terminals 220 can be mounted onto the connector housing 204 along an upward installation direction 221 in the transverse direction T. For instance, each of the electrical terminals 220 are first aligned with a corresponding one of the retention slots 232. Next, each electrical terminal 220 is inserted into the respective retention slot 232 so as to mount the electrical terminals 220 onto the connector housing 204 such that the intermediate portion 250 extends in the middle portion 232b of the retention slot 232 along the bottom end 208 of the housing body 205, the mounting arm 262 extends into the rear portion 232c of the retention slot 232 of the rear retention wall 227, and the retention arm 252 extends into the front portion 232a of the retention slot 232 of the front retention wall 226.

In accordance with the illustrated embodiment, the intermediate region 252b can extend through, and can be press-fit through, the respective front portion 232a of the retention slot 232, and can further extend through, and can be press-fit in, the widow 231. The bent end 263 of the mounting arm 262 can extend through, and can be press fit through, the rear portion 232c of the retention slot 232. When the electrical terminals 220 are mounted to the connector housing 204, the contact surface 258 of the mating end 222 can be displaced forward from the front retention wall 226, and from the front portion 232a of the respective retention slots 232, in the lateral direction A. Thus, the contact surfaces 258 of the electrical terminals 220 can be placed in abutment contact with electrical terminals of the complementary electrical device so as to mate the electrical connector 202 with the complementary electrical device. Further, when the electrical terminals 220 are mounted to the connector housing 204, the contact surface 264 extends forward from the rear retention wall 227, and from the rear portion 232c of the respective retention slots 232, and into the housing reception slot 225.

Referring now to FIG. 5A, when the electrical terminals 220 are mounted in the connector housing 204, the contact surfaces 264 of the mounting ends 224 are spaced from an opposed the inner housing surface 223, which can be stationary as illustrated, a first distance D1 along the lateral direction A. The flex cable 22 defines a thickness D2 between opposed surfaces of the flex cable 22. The thickness D2 is measured in the lateral direction A, which is the same direction that the first distance D1 is measured, when the flex cable 22 is disposed in the housing reception slot 225. The thickness D2 is less than or substantially equal to the first distance D1, such that the flex cable 22 can be loosely disposed in the housing reception slot 225 such that the contact pads 27 are aligned with the contact surfaces 264 of the respective mounting ends 224.

Once the electrical terminals 220 have been installed on the connector housing 204, the mating ends 222 of the electrical terminals 220 is configured to be placed in electrical communication with respective complementary electrical terminals of a complementary electrical device, which can be any device as desired such as a sensor or processor, or can alternatively be a complementary electrical connector, which is in turn electrically connected to another electrical device, such as a sensor or processor. As the mating ends 222 are brought into contact to mate with the respective complementary electrical terminals, the corresponding electrical terminals 220 can flex such that the mating ends 222 resiliently deflect toward the connector housing 204, and toward the corresponding mounting ends 224, under a spring force of the corresponding electrical terminals 220. Furthermore, the electrical connector 202 is devoid of a retention member that would attach to the complementary electrical device and secure the electrical connector 202 to the complementary electrical device so as to secure the mating ends 222, for instance at the respective contact surfaces 258, against the respective complementary electrical terminals.

The mounting ends 224 can be placed into mechanical contact and electrical communication with the contact pads 27 of the flex cable 22, and thus in electrical communication with the conductive layers 25 of the flex cable 22. For instance, the contact surface 264 can be placed in contact with the contact pads 27 of the flex cable 22 so as to mount the electrical connector 202 to the flex cable 22. The mating ends 222 and mounting ends 224 can be compliant, so as to be spring biased in contact with the complementary electrical terminals and flex cable 22, respectively.

Referring now FIGS. 5A-B, the electrical connector 202 includes a lock 280 that is movable between an unlocked configuration whereby the flex cable 22 can be inserted into and out of the housing reception slot 225 and a locked position whereby the lock 280 secures the flex cable 22 against the electrical terminals 220 such that the contact pads 27 are electrically connected with the electrical terminals 220. In particular, when the lock 280 is in the locked position, the contact pads 27 are in contact with the contact surfaces 264 of the mounting ends 224. In accordance with the illustrated embodiment, the flex cable 22 abuts both the contact surfaces 264 and with the lock 280, for instance at the locking member 306.

Referring to FIG. 2C, FIGS. 3B-D, and FIGS. 4A-B, in accordance with the illustrated embodiment, the lock 280 includes a lock body 282 that can be configured as a plate or any alternative suitable geometric shape as desired, and defines an outer or upper surface 284 and an opposed inner or lower surface 285 that is spaced from the upper surface 284 along the transverse direction T. The lock body 282 further defines a front surface 288 and a rear surface 286 that is opposite the front surface 288 along the lateral direction A. The lock body 282 further defines a pair of opposed side surfaces that are spaced along the longitudinal direction L. The lock 280 defines a lock reception slot 292 that extends through the lock body 282 from the upper surface 284 through the lower surface 285 along the transverse direction T at a location between the opposed sides 290 and between the front and rear surfaces 288 and 286, respectively. The lock reception slot 292 can be aligned with the housing reception slot 225 along the transverse direction T when the lock 280 is mounted to the connector housing 204 in the locked position, such that both the lock reception slot 292 and the housing reception slot 225 are configured to receive the flex cable 22. Thus, the reception slot 219 of the electrical connector 202 can include the lock reception slot 292 and the housing reception slot 225 that are configured to receive the flex cable 22. It should therefore be appreciated that both the lock reception slot 292 and the housing reception slot 225 define a respective dimension in the lateral direction A that is greater than the thickness D2 (see FIG. 5A) of the flex cable 22, and further define a respective dimension in the longitudinal direction L that is greater than that of the flex cable 22.

The lock 280 can further include at least one mounting arm, such as a pair of opposed mounting arms 294 that extend from the lock body 282, for instance the rear end of the lock body 282, and are configured to be attached to the connector housing 204. In accordance with the illustrated embodiment, the mounting arms 294 are configured to be slidably attached to the connector housing 204 such that the mounting arms 294 are slidable along the connector housing 204 in the transverse direction T, which is substantially parallel to the inner housing surface 223. In accordance with the illustrated embodiment, the mounting arms 294 are further configured to be pivotally attached to the connector housing 204 such that the mounting arms 294 can pivot about a pivot axis that is substantially perpendicular to the transverse direction T. For instance, the pivot axis can extend in the longitudinal direction L. The mounting arms 294 can be spaced from each other a distance in the longitudinal direction L that is substantially equal to the longitudinal length of the rear retention wall 227 in the longitudinal direction L, such that the mounting arms 294 can be attached to opposed sides 214 of the connector housing 204, for instance at the rear retention wall 227.

The mounting arms 294 can be integral and monolithic with the lock body 282 as illustrated, or can be discreetly attached to the lock body 282. In accordance with the illustrated embodiment, each of the mounting arms 294 can define a proximal end 294a that is attached to the lock body 282 and an opposed free distal end 294b. Each of the mounting arms 294 can further include an engagement member 296 that is configured to engage a complementary engagement member 298 of the connector housing 204 so as to attach the lock 280 to the connector housing 204. The engagement members 296 of the lock 280 are configured as projections 304 that extend from the mounting arms 294, for instance at the distal ends 294b. The projections 304 are sized to be received in complementary engagement members 298 of the connector housing so that the lock 280 is pivotally connected to the connector housing 204 and slidable along the connector housing 204 in the transverse direction.

In accordance with the illustrated embodiment, the engagement members 298 of the connector housing 204 can be configured as a slot 300 that extends into the sides 214 of the rear retention wall 227 along the longitudinal direction L. Each of the slots 300 can be elongate in the transverse direction T, and can extend from the bottom end 208 of the rear retention wall 227 toward the top end 206 of the rear retention wall 227, and can terminates at a location inwardly spaced form the top end 206 of the rear retention wall 227. The slots 300 are sized to slidably receive the projections 304 of the mounting arms 294. Thus, the connector housing 204 defines a pair of engagement members 298 that are configured to slidably and pivotally engage the engagement member 296 of the lock 280.

Thus, in accordance with the illustrated embodiment, the engagement members 298 of the connector housing 204 are configured as guides that slidably and pivotally receive the respective engagement members 296 of the lock 280 such that the lock 280 is slidable along the engagement members 298 in the transverse direction T, and the lock 280 is configured to pivot in the engagement members 298 along a pivot axis that extends in the longitudinal direction L, which is the same direction that the mounting arms 294 are spaced. In accordance with the illustrated embodiment, the engagement members 296 of the lock 280 are movable along the engagement member 298 of the connector housing 204 between a first end that is proximate to the bottom end 208 of the connector housing 204 toward a second end that is proximate to the top end 206 of the connector housing 204. The lock 280 is configured to pivot with respect to the connector housing 204 about the pivot axis at any location between and including the first and second ends. It should be appreciated, however, that the engagement members 298 and 296 can engage in accordance with any suitable alternative embodiment. For instance, the engagement members 298 of the connector housing can be configured as projections and the engagement members 296 of the lock 280 can be configured as recesses that receive the engagement members 298 of the connector housing 204 so that the lock 280 is movable with respect to the connector housing 204 in the manner described above.

The lock 280 further includes a locking member 306 in the form of a projection 308 that extends down from the lower surface 285 of the lock body 282 and is sized to be received in the housing reception slot 225 of the connector housing 204. The projection 308 can extend along part or substantially all of the longitudinal length of the lock body 282, and defines a length in the longitudinal direction L that is substantially equal to the length of the reception slot 219 in the longitudinal direction L or less than the length of the reception slot 219 in the longitudinal direction L. The projection 308 can further extend down from the lock body 282 in the transverse direction T to a depth that is substantially equal to the depth of the reception slot 219 along the transverse direction T. For instance, the projection 308 can abut the bottom end 208 of the connector housing 204, for instance at the housing body 205, when the lock 280 is mounted onto the connector housing 204 in the locked position. Alternatively, the projection 308 can extend down from the lock body 282 in the transverse direction T to a depth that is less than the depth of the reception slot 219 along the transverse direction T. For instance, the projection 308 can be spaced above the bottom end 208 of the connector housing 204, for instance at the housing body 205, along the transverse direction T when the lock 280 is mounted onto the connector housing 204 in the locked position. The projection 308 can define a contoured surface that is configured to abut a complementary contoured surface of the inner housing surface 223 when the lock 280 is in the locked position. The projection 308 can define a thickness D3 along the lateral direction A when the lock 280 is mounted onto the connector housing 204 in the locked position. The thickness D3 is at least substantially equal, for instance greater than, the difference between the distance D1 between the contact surfaces 264 of the mounting ends 224 and the inner housing surface 223 and the thickness D2 of the flex cable 22 when the mounting ends 224 of the electrical terminals are unflexed, and thus in their neutral positions.

Referring now to FIGS. 3B-3D and FIGS. 4A-4C, the lock 280 is mounted to the connector housing 204 at a first position by inserting the projections 304 into the slot 300. For instance, the slot 300 can be open at its bottom end proximate the bottom end 208 of the connector housing 204, and the projections 304 can be inserted upward along the transverse direction T along the slot in the direction of Arrow 301. When the lock 280 is initially mounted to the connector housing 204 at a location proximate to the bottom end 208, the connector housing 204, and in particular the rear retention wall 227, can interfere with the projection 308 so as to prevent the lock 280 from pivoting along a direction 305 that aligns the projection 308 with the housing reception slot 225 along the transverse direction. Accordingly, the lock 280 can be translated upward along the transverse direction T with respect to the connector housing 204 (e.g., along the slot 300) toward the top end 206 to a second position whereby the projection 308 is removed from interference with the connector housing 204 with respect to pivotal motion of the lock 280 about direction 305 with respect to the connector housing 204.

Once the lock 280 is in the second position, the lock 280 can be pivoted with respect to the connector housing 204 along the direction 305 to a third position whereby the locking member 306 is aligned with the housing reception slot 225, and in particular at least partially aligned with the gap that extends along the lateral direction A between the contact surface 264 of the electrical terminals 220 and the inner housing surface 223. The lock 280 can then be translated downward along the transverse direction T with respect to the connector housing 204 such that the engagement member 296 of the lock 280 translates along the complementary engagement member 298 of the connector housing 204 to a fourth locked position whereby the locking member 306 to be inserted into the housing reception slot 225 between the contact surfaces 264 and the inner housing surface 223. As will be described in more detail below, when the lock 280 is in the locked position, the lock 280 is configured to capture the flex cable 22 between the locking member 306 and the mounting ends 224 of the electrical terminals. It should be appreciated that the first, second, and third positions of the lock 280 as described above are unlocked positions.

For instance, referring now to FIGS. 5A-B, a portion of the flex cable 22 including the contact pads 27 are inserted through the lock reception slot 292 and into the housing reception slot 225 when the lock 280 is in the unlocked position. In particular, the length of the housing reception slot 225 in the longitudinal direction L can be substantially equal to the width of the flex cable 22 in the longitudinal direction L when the flex cable 22 is disposed in the housing reception slot. Furthermore, the flex cable 22 can be inserted into the housing reception slot 225 until the first end 29 of the flex cable 22 abuts the bottom end 208 of the connector housing 204. Accordingly, the flex cable 22 can be received in the housing reception slot in a desired position such that the contact pads 27 are aligned with selective contact surfaces 264 at the mounting end 224 of the electrical terminals 220. The flex cable 22 can be inserted through the lock reception slot 292 and into the housing reception slot 225 when the lock 280 is in the unlocked position, both when the locking member 306 is aligned with the housing reception slot 225 and when the locking member 306 is not aligned with the housing reception slot 225. In fact, the flex cable 22 can be inserted through the lock reception slot 292 and into the housing reception slot 225 before the lock 280 is mounted to the connector housing 204.

Once the flex cable 22 is inserted through the lock reception slot 292 and into the housing reception slot 225 in an inserted position whereby the contact pads 27 are aligned with the contact surfaces 264 of the electrical terminals 220, the lock 280 can be moved to the locked position, whereby the locking member 306 is translated to a position between the flex cable 22 and the inner housing surface 223 along the lateral direction A. As described above, the thickness D3 of the locking member 306, and in particular of the projection 308, is at least substantially equal, for instance greater than, the difference between the distance D1 between the contact surfaces 264 of the mounting ends 224 and the inner housing surface 223 and the thickness D2 of the flex cable 22 when the mounting ends 224 are unflexed, and thus in their respective neutral, positions. Accordingly, when the lock 280 is in the locked position without the flex cable 22 in the housing reception slot 225 (see FIG. 4C), the electrical connector 202 defines a distance between the locking member 306 and the contact surfaces 264 of the mounting ends 224 of the electrical terminals 220 along the lateral direction A that is less than the thickness D2 of the flex cable 22. Otherwise stated, the electrical connector 202 defines a distance between the contact surfaces 264 and the opposed inner housing surface 223 along the lateral direction A when the mounting ends 224 are in the neutral position, and the distance minus the thickness D3 of the projection 308 is less than the thickness D2 of the flex cable 22.

As a result, when the lock 280 is moved to the locked position with the flex cable 22 in the inserted position, the locking member 306, and thus the lock 280, applies a biasing force against the flex cable 22 toward the mounting ends 224 of the electrical terminals 220 in the lateral direction A. The biasing force is further communicated to the mounting ends 224 of the electrical terminals 220, which causes the mounting ends 224 to resiliently flex along the lateral direction A away from the opposed inner housing surface 223 to respective flexed positions. Accordingly, the mounting ends 224, and in particular the contact surfaces 264, are spaced from the opposed inner housing surface 223 a first distance when in the neutral position, and spaced from the opposed inner housing surface 223 a second distance when in the flexed position, such that the second distance is greater than the first distance.

Thus, when the mounting ends 224 are in their flexed positions, the distance between the contact surfaces 264 and the opposed inner housing surface 223 along the lateral direction A is substantially equal to the combined thicknesses D2 and D3 of the flex cable 22 and the locking member 306, respectively. The combined thicknesses D2 and D3 of the flex cable 22 and the locking member 306, respectively, can be greater than the first distance between the mounting ends 224 and the opposed inner housing surface 223 when the mounting ends 224 are in the respective neutral positions.

The electrical terminals 220 have a spring force that resists the flexing of the mounting end 224 from the neutral position to the flexed position. The spring force is substantially normal to the contact pads 27, and acts against the contact surfaces 264 such that the contact surfaces 264 can apply a retention force against the contact pads 27 that resists removal of the flex cable 22 from the electrical connector 202 when the lock 280 is in the locked position. The lock 280 can subsequently be moved from the locked position to the unlocked position when it is desired to remove the flex cable 22 from the electrical connector 202. Accordingly, when the lock 280 is in the unlocked position, the flex cable 22 can be mounted to the electrical terminals 220 and removed from the electrical terminals 220. When the lock 280 is in the locked position, the flex cable 22 is secured to the electrical terminals 220 and captured between the mounting ends 224 and the opposed inner housing surface 223. For instance, in accordance with the illustrated embodiment, the flex cable 22 abuts and is captured between the mounting ends 224 and the locking member 306.

The flex cable 22 can be placed in electrical communication with the electrical terminals 220 at the first end 29, and can be electrically connected to a complementary electrical device, such as a sensor or a processor, at a second end that is opposite the first end 29. Thus, the flex cable 22 can place a processor in electrical communication with the mounting ends 224 of the electrical terminals 220. The mating ends 222 of the electrical terminals 220 can be electrically connected to a sensor. Conversely, the flex cable 22 can place a sensor in electrical communication with the mounting ends 224 of the electrical terminals 220 and the mating ends 222 can be electrically connected to a processor. It should be appreciated that the lock can secure a flexible connection to a complementary electrical device, while allowing the electrical connector 202 to have a compact design while providing for ease of manufacturability.

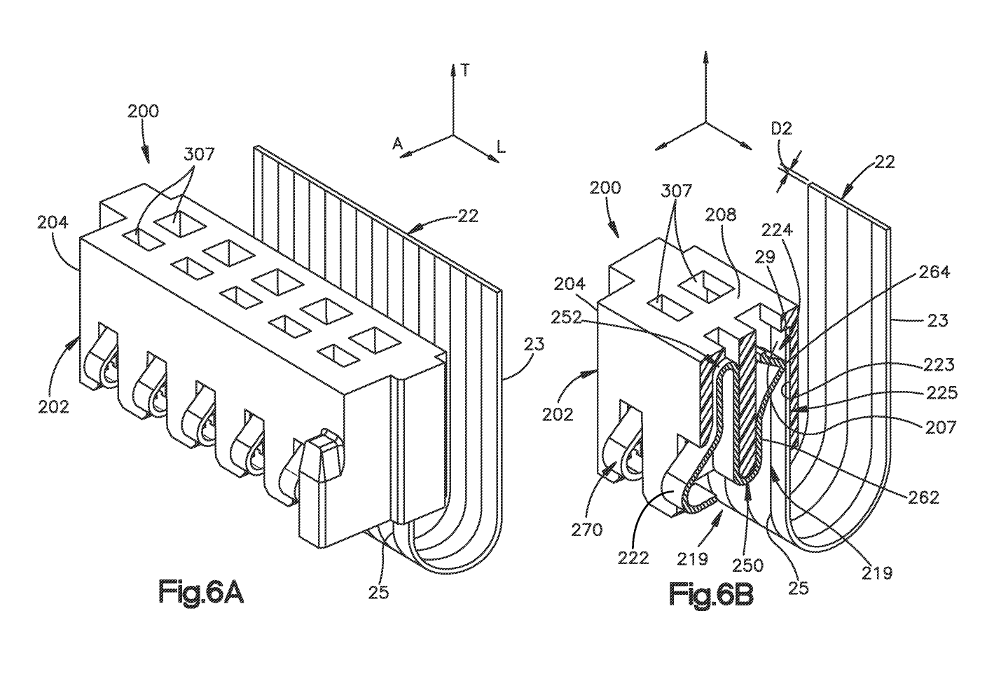

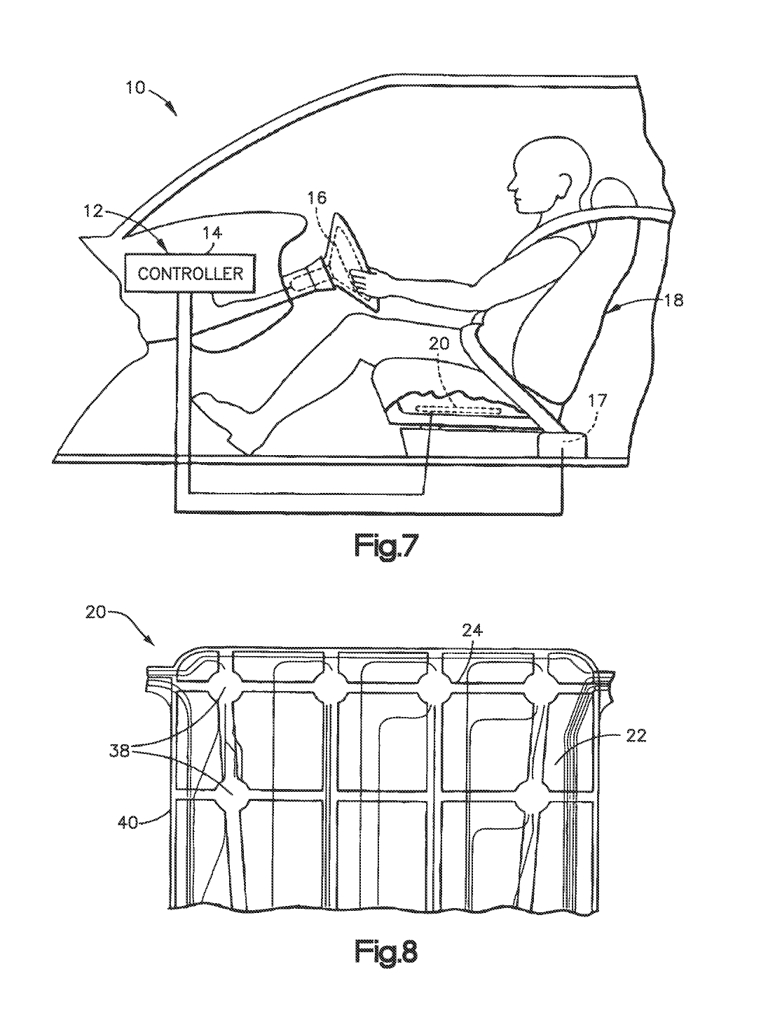

While the electrical connector 202 has been described as including the connector housing 204, the electrical terminals, and the lock 280 in accordance with one embodiment, it should be appreciated that the electrical connector 202 can be constructed in accordance with any suitable alternative embodiment. For instance, referring to FIGS. 6A-B, the electrical connector 202 can be devoid of the lock 280. Accordingly, the housing reception slot 225 of the connector housing 204 can be sized such that the contact surfaces 264 of the mounting ends of the electrical terminals 220 and the opposed inner housing surface 223 are spaced from each other a distance along the lateral direction A that is less than the thickness D2 of the flex cable 22 when the mounting ends 224 are in the respective neutral positions.

Thus, the flex cable 22 can be inserted between the contact surfaces 264 and the opposed inner housing surface 223 under a force sufficient to cause the mounting ends 224 of the electrical terminals 220 to flex away from the opposed inner housing surface 223 from the neutral position to the flexed position, whereby the distance along the lateral direction A between the mounting ends 224 and the opposed inner housing surface 223 is substantially equal to the thickness D2 of the flex cable 22. For instance, the flex cable 22 can abut both the contact surfaces 264 and the opposed inner housing surface 223. The flex cable 22 can be inserted into the housing receptacle slot 225, which can define the reception slot 219 of the electrical connector 202, to a depth along the transverse direction T until the flex cable 22 abuts the connector housing 204, for instance at the bottom end 208, which places the contact pads 27 in alignment with the contact portions 264. The electrical terminals 220 have a spring force that resists the flexing of the mounting end 224 from the neutral position to the flexed position. The spring force is substantially normal to the contact pads 27, and acts against the contact surfaces 264 such that the contact surfaces 264 can apply a retention force against the contact pads 27 that resists removal of the flex cable 22 from the electrical connector 202. Thus, the flex cable 22 is secured to the electrical terminals 220, and abuts and is captured between the mounting ends 224 and the opposed inner housing surface 223. It should be appreciated that deflection of the mounting ends 224 does not cause the mating ends 222 to deflect in accordance with the illustrated embodiment.

Alternatively or additionally, the electrical connector 202 can define a plurality of access apertures 307 that extend through the connector housing 204 along the transverse direction T, for instance through the bottom end 208 of the connector housing, at a location aligned with the housing reception slot 225. For instance, each of the access apertures 307 can be aligned with a respective one of the mounting ends 224 in the transverse direction T. Accordingly, a biasing tool can be inserted through the access apertures 307 and into contact with the electrical terminals 220, for instance at the mounting ends 224. Lateral movement of the biasing tool against the mounting ends 224 can bias the mounting ends 224 away from the opposed inner housing surface 223 to a flexed position, thereby increasing the distance between the contact surfaces 264 and the opposed inner housing surface 223.

The distance can be increased to an amount greater than the thickness D2 of the flex cable 22, such that the flex cable 22 can be freely inserted into the housing reception slot 225. Alternatively, the mounting ends 224 can be partially flexed such that the distance is increased to an amount that is less than the thickness D2 of the flex cable 22, such that the flex cable 22 can be inserted into the housing reception slot 225 under a reduced force compared to when the mounting ends 224 are in their neutral positions. The biasing tool can then be removed, such that the electrical terminals 220 are in their respective flexed positions, and the flex cable 22 is captured between mounting ends 224 and the opposed inner housing surfaces 223 in the manner described above. It should be appreciated that when the flex cable 22 is connected to the mounting ends 224 of the electrical terminals 220 of the electrical connector 202 illustrated FIGS. 6A-B, the contact pads 27 and the conductive layers 25 face toward the mating ends 222 of the electrical terminals 220. The electrical terminals 220 illustrated in FIGS. 6A-B can be referred to as battery-type terminals in that both the mating end 222 and the mounting end 224 are configured to resiliently flex or compress with respect to each other about the substantial u-shaped bent ends defined by the retention arm 252 and the intermediate portion 250, respectively. In accordance with the illustrated embodiment, when the mating ends 222 are brought into contact with respective complementary electrical terminals of a complementary electrical device to mate with the respective complementary electrical terminals, the mating ends 222 resiliently deflect toward the connector housing 204, and further toward the mounting ends 224, under a spring force provided by the electrical terminals 220. Furthermore, in accordance with the illustrated embodiment, the mating ends 222 extend out the connector housing 204, and the mounting ends 224 are disposed within the connector housing 204. Furthermore, the electrical connector 202 is devoid of a retention member that would attach to the complementary electrical device and secure the electrical connector 202 to the complementary electrical device so as to secure the mating ends 222, for instance at the respective contact surfaces 258, against the respective complementary electrical terminals.

When the flex cable 22 is connected to the mounting ends 224 of the electrical terminals 220 of the electrical connector illustrated in FIG. 1A, the contact pads 27 and the conductive layers 25 face away from the mating ends of the electrical terminals 220. Furthermore, while the mounting end 224 extends from the mounting arm 262 toward the mating end 222 as illustrated in FIG. 2B, the mounting end 224 can extend from the mounting arm 262 away from the mating end 222 as illustrated in FIG. 6B.

In accordance with one embodiment, a method is provided for attaching a flex cable to an electrical connector of the type that includes a connector housing, such as the connector housing 204, and at least one electrical terminal, such as electrical terminal 220, that is supported by the connector housing 204 and includes a mating end 222 and a mounting end 224. The method includes the step of inserting a flex cable, such as the flex cable 22, into a housing reception slot, such as the housing reception slot 225, at a location between the mounting end 224 and an opposed inner housing surface, such as the inner housing surface 223. The method further includes the step of biasing the mounting end 224 away from the inner housing surface 223. The method further includes the step of resiliently capturing the flex cable 22 between the mounting end 224 and the inner housing surface 223. The biasing step can further include the step of mounting a lock, such as the lock 280 described above, to the connector housing 204 and moving the lock 280 from an unlocked position to a locked position whereby a locking member, such as the locking member 306, of the lock 280 extends into the housing reception slot 225 so as to capture the flex cable 22 between the locking member 306 and the mounting end 224. The method can further include the step of bringing the mating end into contact with a complementary electrical terminal of a complementary electrical device to mate the mating end with the complementary electrical terminal, such that the mating end resiliently deflects toward the mounting end, without securing the electrical connector to the complementary electrical device.

Referring to FIG. 7, there is shown a diagrammatic view of a portion of a vehicle 10 having a safety restraint system 12 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

A similar safety restraint system is described in U.S. Pat. Nos. 6,129,168 and 6,932,382, the disclosure of each of which is hereby incorporated by reference in its entirety. The safety restraint system 12 generally comprises a controller 14, airbags 16, 17, and a seat sensor device 20 located in a seat 18. In the embodiment shown, the air bag 16 is a steering wheel mounted air bag. The air bag 17 is a seat belt mounted air bag. The controller 14 can be connected to other air bags in the vehicle 10, such as a passenger side dashboard mounted air bag and side mounted air bags, for example. The controller 14 is connected to the air bags 16, 17 to control their deployment. The controller 14 is also connected to various sensors located about the vehicle as is generally known in the art.

One of the sensors connected to the controller 14 is the seat sensor device 20 located in the seat 18. In the embodiment shown, the seat sensor device 20 is shown in the driver's seat. One or more additional seat sensor devices could be located in one or more of the passenger seats. The seat sensor device 20 is adapted to determine the size and position of a person sitting in the seat. The information sensed by the seat sensor device 20 is transmitted back to the controller 14 to allow the controller to determine if and/or at what force the air bags 16, 17 should be deployed in the event of an accident.

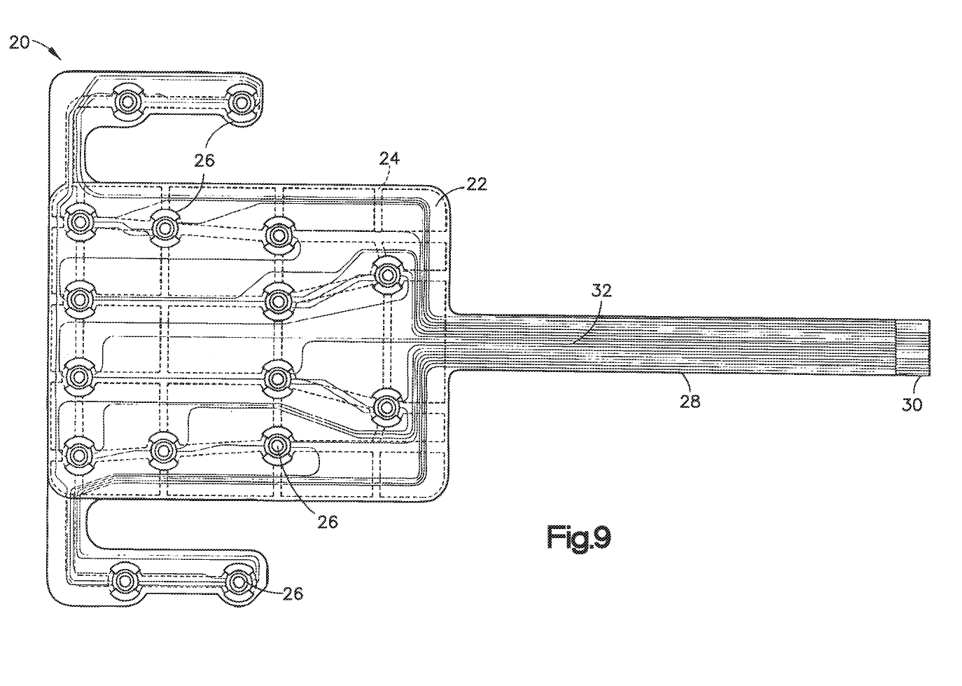

Referring now also to FIGS. 8-10, the seat sensor device 20 generally comprises a flex cable 22, a frame 24, and a plurality of Hall effect sensor assemblies 26. The controller 14 can include the electrical connector 202 mounted to the flex cable 22 as described above, and a complementary electrical device mated to the electrical connector 202 and having a processor that receives signals from the various sensors to determine if and/or at what force the air bags 16, 17 should be deployed. As seen best in FIG. 8, the flex cable 22, which can be a flexible printed circuit, is provided in the general shape of a mat. The flex cable 22, which can be a flex cable mat, has a connection tail 28 with contact sections 30. Electrical conductors 32 extend through the flex cable 22, which can be a flex cable mat, and are covered by electrical insulation. The frame 24 is generally comprised of molded plastic. The frame 24 provides a support for the flex cable 22, which can be a flex cable mat. The frame 24 is located against a bottom side of the flex cable 22, which can be a flex cable mat. As shown in FIG. 11, the frame 24 comprises pairs of snap lock latches 34 which extend through holes in the flex cable 22, which can be a flex cable mat, such that the snap lock latches are located on the top side of the flex cable mat. Each of the opposing pairs of snap lock latches 34 form a receiving area 36 therebetween on the top side of the flex cable 22, which can be a flex cable mat. As shown best in FIG. 9, the frame 24 comprises support sections 38 connected to each other by a support lattice section 40. The support sections 38 comprise a general flat disk shape. The snap lock latches 34 extend from a top side of the support sections 38. Thus, the support sections 38 provide a substantially flat surface 42 on the top side of the frame 24 between each of the pairs of snap lock latches 34.

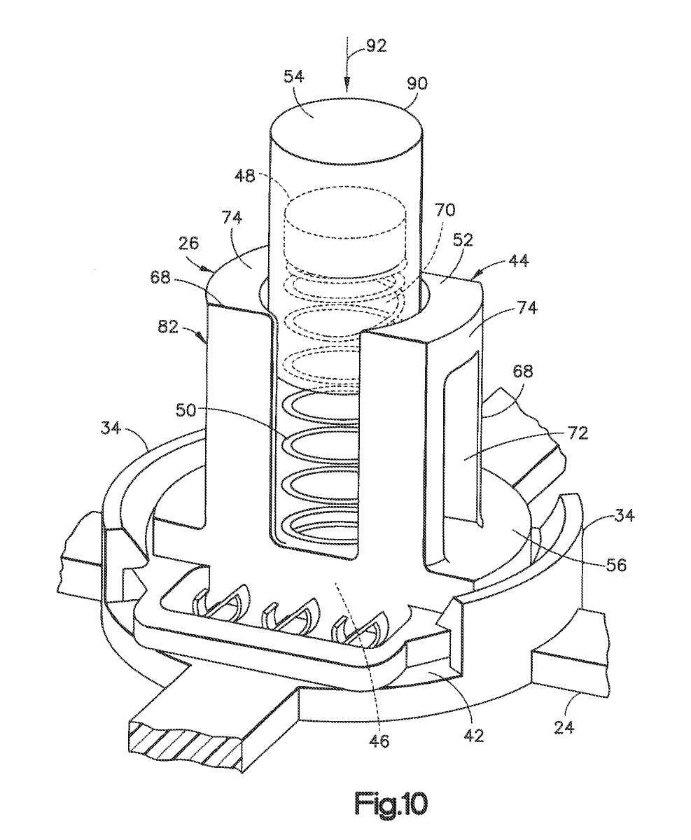

Referring now particularly to FIG. 10, a portion of the frame 24 is shown with one of the Hall effect sensor assemblies 26 attached thereto. FIG. 10 shows the seat sensor device without showing the flex cable 22, which can be a flex cable mat, merely for the sake of clarity. The flex cable 22, which can be a flex cable mat, would be located between the flat surface 42 and the bottom side of the Hall effect sensor assembly 26. The flex cable mat is essentially sandwiched between the bottom side of the sensor assembly 26 and the flat surface 42. The Hall effect sensor assembly 26 generally comprises a housing 44, a Hall effect sensor 46, a magnet 48, and a spring 50. In the embodiment shown, the seat sensor device 20 comprises sixteen of the Hall effect sensor assemblies 26 (see FIG. 8). However, in alternate embodiments, the seat sensor device could comprise more or less than sixteen Hall effect sensor assemblies. In addition, the Hall effect sensor assemblies could be positioned in any suitable type of array on the flex cable 22, which can be a flex cable mat.

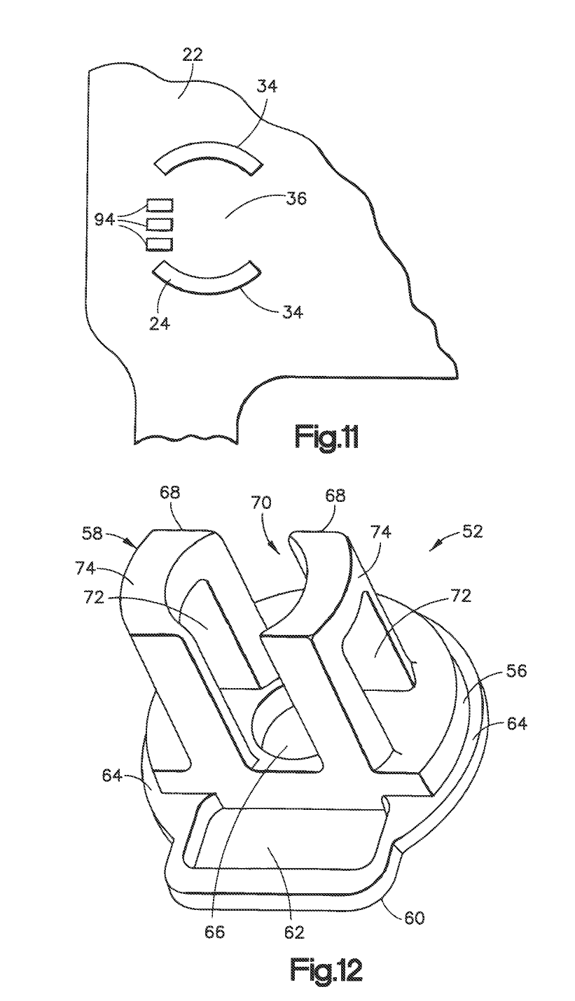

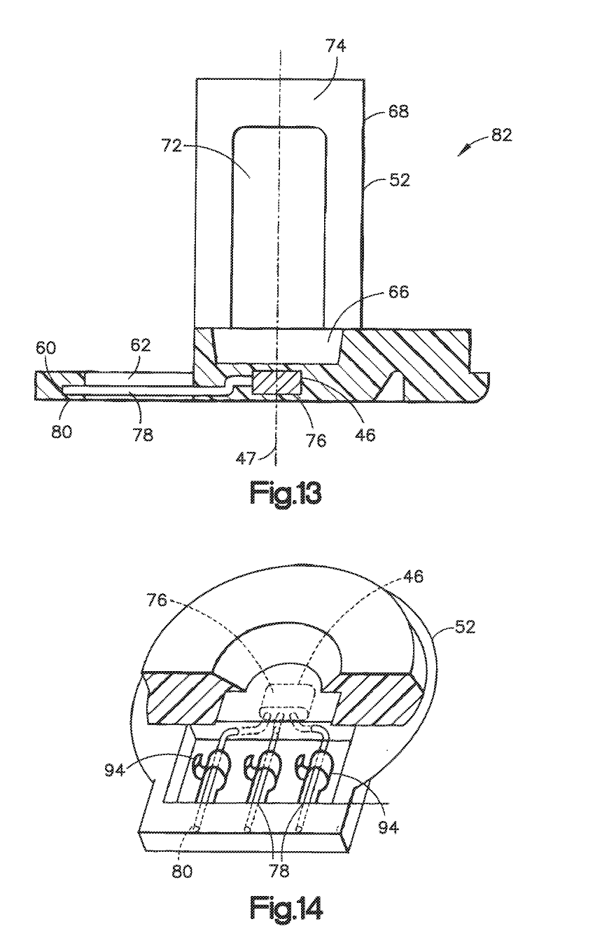

Referring also to FIGS. 12-16, the housing 44 generally comprises a first housing member 52 and a second housing member 54. The first housing member 52 is preferably comprised of molded plastic or polymer material. As seen best in FIGS. 12 and 13, the first housing member 52 generally comprises a base section 56 and a general tube section 58. The base section 56 generally comprises an extension 60 having an open aperture 62, snap lock ledges 64, and a central spring cavity 66. The general tube section 58 extends in an upward direction from the top side of the base section 56 around the spring cavity 66. The general tube section 58 generally comprises two opposing curved columns 68. The two columns 68 defined a magnet movement path therebetween. More specifically, the two columns 68 define an area 70 which is adapted to receive the second housing member 54 which houses the magnet as further described below. In the embodiment shown, each of the columns 68 include an alignment slot 72 therein. The alignment slots 72 are used to movably attach the second housing member 54 to the first housing member 52 as further described below. The top sides of the alignment slots 72 are closed by transverse sections 74 of the columns.

Referring particularly to FIGS. 13 and 14, the Hall effect sensor 46 is housed, at least partially, inside the first housing member 52. Thus, the first housing member 52 and the Hall effect sensor 46 form a first subassembly 82. In a preferred embodiment of the present invention, the first housing member 52 comprises an overmolded housing which is overmolded over portions of the Hall effect sensor 46. The Hall effect sensor 46 generally comprises a sensing section 76 and three electrical leads 78. One lead is for power, one lead is for ground and one lead is for signals. In a preferred embodiment, the Hall effect sensor 46 is a range taking sensor capable of continuous signaling of distance of the magnet relative to the sensor 46. However, in alternate embodiments, the Hall effect sensor could be adapted to signal two or more range settings, such as by using a step capable sensor.

The three electrical leads 78 span across the open aperture 62 of the extension 60 in the first housing member 52 and, more specifically, the electrical leads 78 comprises exposed middle sections which do not have the overmolded first housing member 52 thereon. The electrical leads 78 comprises distal ends 80 which are fixedly attached to the first housing member 52 by the overmolding process. The proximal end of the electrical leads 78 are also fixedly attached to the first housing member by the overmolding process. Thus, the first housing member 52 retains the exposed middle sections of the electrical leads in a fixed, spaced orientation relative to each other and a fixed orientation relative to the overmolded first housing member 52.

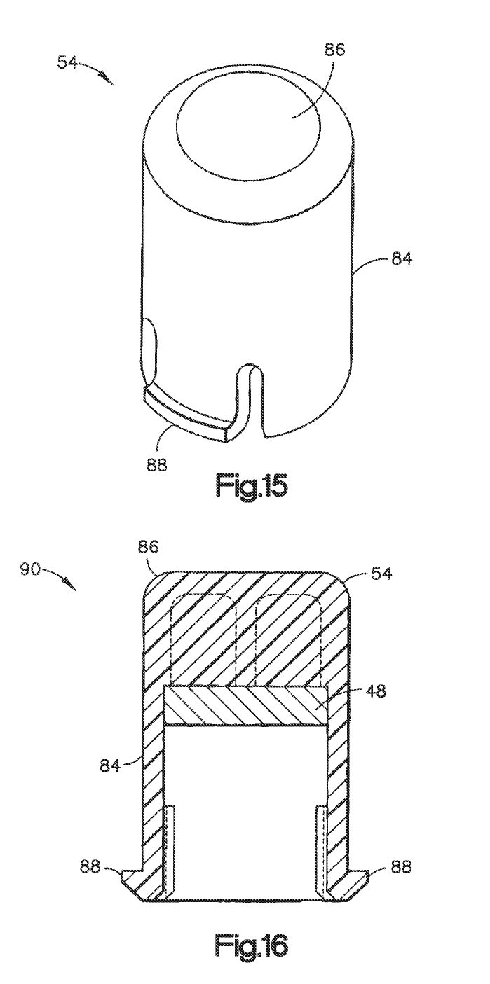

Referring particularly to FIGS. 15 and 16, the second housing member 54 generally comprises a one-piece member preferably comprised of molded plastic or polymer material. The second housing member 54 generally comprises a tube shaped section 84, a top section 86 and snap lock latches 88 forming a bottom part of the tube shaped section 84. The magnet 48 is located inside the tube shaped section 84 against the bottom side of the top section 86. The magnet 84 is preferably press fit inserted into the second housing member. Thus, the second housing member 54 and magnet 48 form a second subassembly 90.

As seen in FIG. 10, the spring 50 is connected between the two subassemblies 82, 90. A first end of the spring 50 is located in the spring cavity 66 of the first housing member 52 (see FIG. 12) and a second opposite end of the spring is located inside the tube shaped section 84 of the second housing member 54. The second opposite end of the spring 50 is located directly against the bottom side of the magnet 48. The spring 50 biases the second subassembly 90 in an upward direction as shown in FIG. 10. In a preferred embodiment the spring is comprised of nonferrous material such that it does not impact the magnetic field.

In order to assemble the two subassemblies 82, 90 and spring 50 together, the spring is placed in the spring cavity 66 and the second subassembly 90 is inserted into the top of the first subassembly 82 as indicated by arrow 92 with the bottom of the second housing member 54 entering into the area 70 between the two columns 68. The area 70 is sized and shaped to slidably received the second housing member 54 therein. As the second housing member 54 is inserted into the area 70, the snap lock latches 88 are resiliently deflected in an inward direction until the latches pass by the transverse sections 74 of the columns 68. The snap lock latches 88 are then able to deflect outward and into the two alignment slots 72. This provides a snap lock connection of the second housing member 54 to the first housing member 52.

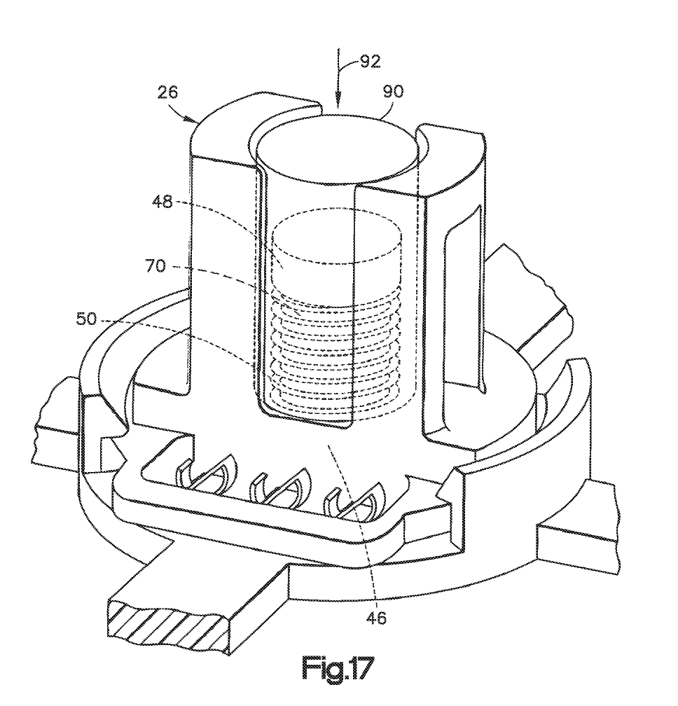

The snap lock connection merely prevents the second subassembly 90 from becoming disengaged from the first subassembly 82. However, the connection of the two subassemblies 82, 90 to each other provides a movable connection. More specifically, the outer portions of the snap lock latches 88 are adapted to vertically slide in the alignment slots 72. Referring also to FIG. 17, the Hall effect sensor assembly 26 is shown similar to that shown in FIG. 10, but in this configuration the second subassembly 90 has been depressed as indicated by arrow 92 in an inward direction; further into the area 70. This results in the spring 50 being resiliently compressed and the magnet 48 being moved closer to the Hall effect sensor 46. When force is reduced on the top surface of the second subassembly 90, the spring 50 can move the second subassembly and the magnet 48 in a direction away from the Hall effect sensor 46. With the present invention, the movably connection between the two housing members 52, 54 provides a telescoping type of movement which allows the magnet to move towards and away from the Hall effect sensor 46 along a Hall effect central sensing axis 47 (see FIG. 13). The movable connection is designed to prevent the magnet 48 from getting out of parallel with the Hall effect sensor 46 by more than ten degrees. In a preferred embodiment, the magnet might only be able to tilt or move out of alignment by 5-10 degrees.

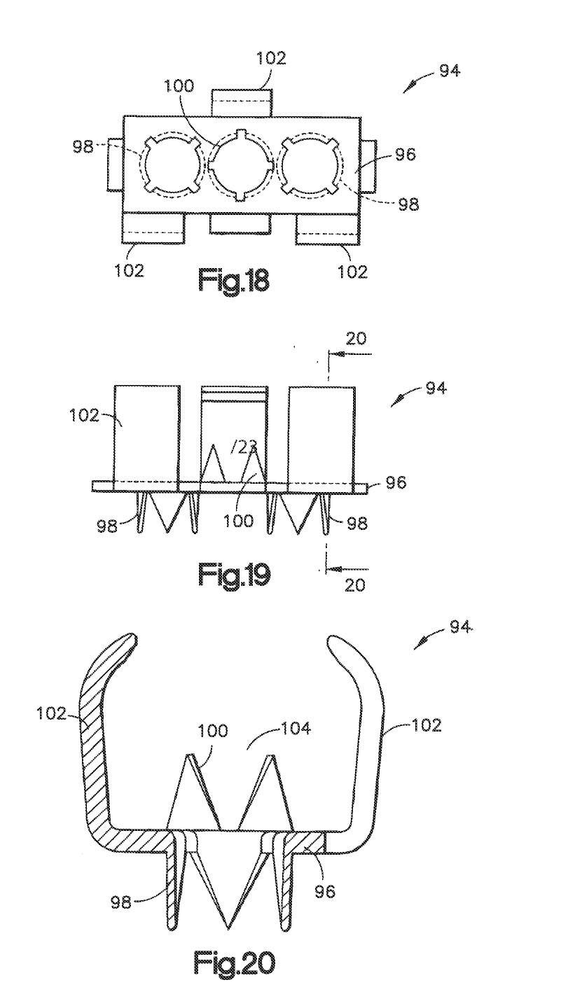

As seen best in FIGS. 11 and 14F, the seat sensor device 20 includes electrical terminals 94. More specifically, in the embodiment shown, three of the terminals 94 are provided at each of the sensor assemblies 26; one terminal for each one of the electrical leads 78 of the Hall effect sensor 46. Referring also to FIGS. 18-20, one of the terminals 94 is shown. Each terminal 94 generally comprises a one-piece electrically conductive member. In a preferred embodiment, the terminal 94 is comprised of flat sheet metal which has been stamped into the shape shown. The terminal 94 generally comprises a center section 96, bottom extending sections 98, a top extending section 100, and upward extending side sections 102.

The terminals 94 are fixedly attached to the flex cable 22, which can be a flex cable mat, before the sensor assemblies 26 are connected. More specifically, the terminals 94 are pressed against the top surface of the flex cable 22, which can be a flex cable mat, with the bottom extending sections 98 piercing through the mat and being deformed outward and upward to form a mechanical and electrical connection with individual ones of the electrical conductors 32 in the mat. When the sensor assemblies 26 are being connected to the flex cable 22, which can be a flex cable mat, and the snap lock latches 34 of the frame 24, the terminals 94 are received in the open aperture 62 of the extension 60 through the bottom of the first housing member 52. The electrical leads 78 of the Hall effect sensors 46 are each positioned into the area 104 between the side sections 102 of one of the terminals.

The side sections 102 are then deformed inward towards the area 104 to clamp the middle exposed sections of the electrical leads 78 into a mechanical and electrical connection with the top extending section 100 and side sections 102 against the top side of the center section 96. If the electrical leads 78 comprise electrical insulation, the relatively sharp edges on the top extending section 100 is adapted to cut through the electrical insulation to insurer electrical contact between the terminal 94 and the electrical conductor of the electrical lead 78. However, in alternate embodiments, any suitable type of terminal or method of electrically connecting the electrical leads 78 to the electrical conductors 32 of the flex cable 22, which can be a flex cable mat, could be provided. However, in the embodiment shown, the terminals 94 are adapted to allow the side sections 102 to be moved to an open position again to allow the sensor assembly 26 to be removed from connection with the terminals. A replacement sensor assembly can be connected to the flex cable mat to replace a broken or faulty original sensor assembly 26. Thus, in a preferred embodiment, the electrical connection of the sensor assembly 26 to the conductors in the flex cable mat is preferably a removable connection. In an alternate embodiment, the electrical connection might not comprise a removable connection.

Referring back to FIG. 10, the sensor assembly 26 is attached to the frame 24 by inserting the base section 56 through the top side of an opposing pair of the snap lock latches 34. The snap lock ledges 64 (see FIG. 12) of the first housing member 52 snap beneath portions of the snap lock latches 34. The present invention, unlike conventional designs, does not need a separate lock to attach the frame to the flex cable mat. With the present invention, the first housing member 52 functions as the lock to attach the flex cable mat to the frame 24. The use of the first housing member 52 as the lock allows the seat sensor device 20 to be manufactured with less components. The assembly of the seat sensor device 20 comprises less steps and is therefore quicker to assemble.

The embodiments described in connection with the illustrated embodiments have been presented by way of illustration, and the present invention is therefore not intended to be limited to the disclosed embodiments. Furthermore, the structure and features of each the embodiments described above can be applied to the other embodiments described herein, unless otherwise indicated. Accordingly, those skilled in the art will realize that the invention is intended to encompass all modifications and alternative arrangements included within the spirit and scope of the invention, for instance as set forth by the appended claims.

What is claimed:

1. An electrical connector configured to mount to a flex cable, the electrical connector comprising:
a connector housing that defines a housing reception slot;
at least one electrical terminal supported by the housing and configured to electrically connect to a flex cable, the electrical terminal defining a mating end and a mounting end, the mounting end disposed in the reception slot and spaced from an opposed inner housing surface, wherein the flex cable is configured to be received between the mounting end and the opposed inner housing surface; and
a lock including a lock body and a locking member that extends from the lock body and is configured to be inserted into the housing reception slot, wherein the lock is movable from an unlocked position to a locked position, such that when in the locked position, the locking member is disposed between the mounting end and the opposed inner housing surface, so as to capture the flex cable between the locking member and the mounting end.

2. The electrical connector as recited in claim 1, wherein the locking member biases the mounting end to flex from a neutral position to a flexed position away from the opposed inner housing surface when the locking member moves from the locked position to the unlocked position.

3. The electrical connector as recited in claim 2, wherein the mounting end is spaced from the opposed inner housing surface a first distance when in the neutral position, and is spaced from the opposed inner housing surface a second distance when in the flexed position, and the second distance is greater than the first distance.

4. The electrical connector as recited in claim 3, wherein the mounting end is in the neutral position when the lock is in the unlocked position.

5. The electrical connector as recited in claim 3, wherein the flex cable and the locking member each defines a respective thickness that, in combination, is greater than the first distance.

6. The electrical connector as recited in claim 3, wherein the flex cable and the locking member each defines a respective thickness that, in combination, is substantially equal to the second distance.

7. The electrical connector as recited in claim 3, wherein the flex cable defines a thickness and the locking member defines a thickness, and the thickness of the locking member is greater than a difference between the first distance and the thickness of the flex cable.

8. The electrical connector as recited in claim 1, wherein the lock is removably attached to the connector housing.

9. The electrical connector as recited in claim 8, wherein the lock is translatably and pivotally coupled to the connector housing.

10. The electrical connector as recited in claim 9, wherein the lock is translatable with respect to the connector housing from a first position to a second position, whereby the lock can be pivoted from the second position to a third position whereby the locking member is aligned with the housing reception slot.

11. The electrical connector as recited in claim 1, wherein the lock defines a lock reception slot that extends through the lock body and is aligned with the housing reception slot when the lock member extends into the housing reception slot, such that both the lock reception slot and the housing reception slot are configured to receive the flex cable.

12. The electrical connector as recited in claim 1, wherein the mating portion extends out from the connector housing.

13. The electrical connector as recited in claim 1, wherein the electrical terminal is a battery- type terminal whereby the mating end and mounting end are resiliently flexible with respect to each other.

14. An electrical connector configured to mount to a flex cable, the electrical connector comprising:
a connector housing that includes an inner housing surface, the inner housing surface defining a housing reception slot; and
at least one electrical terminal supported by the housing and configured to electrically connect to a flex cable, the electrical terminal defining a mating end and a mounting end, wherein (i) the mating end extends out the connector housing and is configured to mate with a complementary electrical terminal of a complementary electrical device, such that the mating end resiliently deflects toward the mounting end, and the electrical connector is devoid of a retention member that would attach to the complementary electrical device and secure the mating end against the complementary electrical terminal, and (ii) the mounting end is disposed in the reception slot and spaced from the inner housing surface, such the flex cable is configured to be received in the reception slot between the mounting end and the opposed inner housing surface.

15. A method of attaching a flex cable to an electrical connector of the type that includes a connector housing and at least one electrical terminal that is supported by the connector housing and includes a mating end and a mounting end, the method comprising the steps of:
inserting a flex cable into a housing reception slot at a location between the mounting end and an opposed inner housing surface;
biasing the mounting end away from the inner housing surface;
resiliently capturing the flex cable between the mounting end and the inner housing surface; and
bringing the mating end into contact with a complementary electrical terminal of a complementary electrical device so as to mate the mating end with the complementary electrical terminal, such that the mating end resiliently deflects toward the mounting end, without securing the electrical connector to the complementary electrical device.

16. The method as recited in claim 15, wherein the biasing step further comprising mounting a lock to the connector housing and moving the lock to from an unlocked position to a locked position whereby a locking member of the lock extends into the reception slot so as to capture the flex cable between the locking member and the mounting end.
